(19) United States
(12) Patent Application Publication
(10) Pub. No.: US 2025/0033172 A1
(43) Pub. Date: Jan. 30, 2025

(54) POWER TOOL WITH COUPLING MECHANISM

(71) Applicant: ATLAS COPCO INDUSTRIAL TECHNIQUE AB, Stockholm (SE)

(72) Inventors: Daniel HALLBERG, Sundbyberg (SE); Niklas GISSELMAN, Vega (SE)

(73) Assignee: ATLAS COPCO INDUSTRIAL TECHNIQUE AB, Stockholm (SE)

(21) Appl. No.: 18/716,271

(22) PCT Filed: Nov. 1, 2022
(86) PCT No.: PCT/EP2022/080442

§ 371 Date: Jun. 4, 2024

(30) Foreign Application Priority Data
Dec. 10, 2021 (SE) 2130351-6

(51) Int. Cl. B25B 23/00; B25B 21/00; B25F 1/04

(52) U.S. Cl. CPC B25B 23/0035; B25B 21/00; B25F 1/04

(57) ABSTRACT

Disclosed herein is a power tool comprising a motor, a drive shaft connected to the motor, a front end defining a cavity comprising a tool side end and a free end, and a coupling mechanism for releasably connecting a removable tool head to the drive shaft. The coupling mechanism comprising two sleeves, a first and a second biasing element and at least one ball that together either put the coupling mechanism in an open position ready to receive the removable tool head or into a closed position upon manual dislocation of the inner sleeve during insertion of another tool head, so that the at least one ball can glide into at least a partial engagement with a recess on the removable tool head and is locked there via the inner projection of the outer sleeve, which outer sleeve is held in position by the first biasing element.

### TECHNICAL FIELD

The invention relates to the field of power tools which comprise removable tool heads that can be replaced. Depending on the work that needs to be performed such a removable tool head can be replaced with another tool head by removing the current tool head and inserting a new tool head. The removable tool heads are typically arranged at the front end of the power tool.

### BACKGROUND OF THE INVENTION

When power tools are provided with a variety of removable tool heads to perform different type of work, the coupling mechanism typically comprises a sleeve arranged at a front end of the power tool, which sleeve can be manually moved backwards away from—or forwards towards—the front end of the power tool so that the removable tool head is released for replacement with another tool head. This replacement procedure is typically difficult and cumbersome for the operator. The drawing back of the sleeve does not give any haptic or acoustic feedback to the operator if the removable tool head is properly released or if the new tool head is properly engaged. Moreover, the engagement usually requires the operator to push the sleeve back forward towards the front end of the power tool in order to lock the removable tool head in the coupling mechanism and the power tool, respectively. Alternatively, the operator needs to pull back the sleeve again for inserting another tool head or by holding the sleeve with one hand during the entire replacement procedure. During the removal part of the replacement procedure often both hands of the operator are needed to remove the removable tool head currently engaged in the power tool via the coupling mechanism, whereby one hand holds the sleeve as explained and the other the tool head. During the insertion part of the other tool head the situation is not much better since one hand needs to control and pull on the sleeve while the other hand inserts the other or new tool head.

In addition to the above these coupling mechanisms are typically rather complicated in their build up, requiring a plurality of elements, recesses, balls and springs in order to function properly, which makes them cumbersome to assemble, prone to reliability issues, heavy and expensive. Examples of such coupling mechanism are for instance shown in the U.S. Pat. No. 10,569,343 B2, which discloses an attachment retainer or driven tool for receiving a socket or bit, whereby the rotational locking is done using splines and grooves and the axial locking is done via balls. As can be seen from the U.S. Pat. No. 10,569,343 B2, the coupling mechanism is designed to be releasably locked by rotating a sleeve or the like around longitudinal axis defined by the socket.

Another example of a coupling mechanism for locking a bit in a bit adapter is shown in EP 3,228,408 A1, which involves however more than one plane with balls. The rotational locking of the coupling mechanism shown in EP 3,228,408 A1 is done via a form fit coupling of a hexagonal or planar bit end with a hexagonal opening having two grooves in the bit adapter for receiving either a hexagonal or planar shaped bit end. The mechanism is designed to lock a bit in the bit adapter. For removal the outer sleeve in EP 3,228,408 A1 can be moved forward towards the bit. This will unlock the bit, since the first ball is now free to move outwards and the bit can be manually removed. Using several planes with balls, thus at least two balls, and a form fit solution for rotational and axial locking and for locking the outer sleeve in an open position makes the design of EP 3,228,408 A1 rather complicated and therewith prone to the above-described shortcomings.

### SUMMARY OF THE INVENTION

In view of the above there is a need to provide a coupling mechanism for a power tool and a power tool that is easy to handle for an operator and effective to manufacture and assemble.

An object of the present invention is to provide a power tool that is safe, easy to handle, efficient and reliable.

In view of the above-mentioned issues, the inventors of the present invention have discovered that it is possible to simplify the coupling mechanism for removable tool heads in a power tool so that only one ball or only one plane of balls is needed for an axial and rotational locking of the removable tool head in the power tool. In addition, the inventors have also discovered that it is possible to simplify the coupling mechanism so that the operator can replace a tool head with one hand. The coupling mechanism is at the same time capable to provide clear haptic and/or acoustic feedback of the locking and releasing of the removable tool head in the coupling mechanism so that the operator can clearly identify whether or not the tool head is properly engaged in the power tool or properly disengaged from it.

Disclosed herein is a power tool comprising a motor, a gear box, a drive shaft connected to the gear box or to the motor via the gear box, the drive shaft defining a longitudinal axis, a front end having at least one through hole, whereby an axis of the through hole extends perpendicular to and through the longitudinal axis, said front end defining a cavity comprising a tool side end and an open end. The power tool further comprises a coupling mechanism for releasably connecting a removable tool head to the drive shaft, the coupling mechanism comprises an outer sleeve being arranged at least partially around the cavity, the coupling mechanism further comprises a first biasing element, at least one ball arranged at least partially within the at least one through hole, said at least one ball further arranged on an inner side of the outer sleeve. The outer sleeve comprises an inclined inner surface and an inner projection adjacent to the inclined inner surface, the first biasing element being arranged at the front end abutting the outer sleeve and the front end. The coupling mechanism is arranged to be moved between an open position, in which the power tool can receive the removable tool head and a closed position, in which the removable tool head is connected to and locked in the power tool and whereby in the open position the at least one ball can be displaced in an outward direction away from the longitudinal axis and in the closed position the displacement in the outward direction of the at least one ball is prevented by the inner projection of the outer sleeve. The coupling mechanism further comprises an inner sleeve arranged at least partially within the cavity, and a second biasing element abutting the tool side end of the cavity and the inner sleeve, whereby in the open position the inner sleeve is preventing the inner projection from abutting the at least one ball.

The above embodiment basically uses two sleeves, two, a first and a second biasing element and at least one ball that together either put the coupling mechanism in an open position ready to receive the removable tool head or into a closed position upon manual dislocation of the inner sleeve during insertion of another tool head, so that the at least one ball can glide into at least a partial engagement with a recess on the removable tool head and is locked there via the inner projection of the outer sleeve, which outer sleeve is held in position by the first biasing element.

This design allows for an efficient construction of the coupling mechanism, which makes the coupling mechanism easy to use for an operator, she/he can basically manage the coupling mechanism with one hand. In addition, the first and second biasing element(s) together with the at least one ball will provide a clear acoustic and haptic feedback upon engagement and locking and release of the removable tool head.

In an embodiment when the power tool is in the closed position, the inner sleeve is biased towards the tool side end by the removable tool head thereby allowing the displacement of the at least one ball inwards towards the longitudinal axis (a) so that the at least one ball can engage at least one recess of the removable tool head, and the inner projection abuts the at least one ball, thereby locking the removable tool head in the power tool via the at least one ball and the at least one recess.

This locking is detectable by the operator by hearing and feeling a click once the at least one ball engages the recess and by a movement of the outer sleeve into a locked position.

In another embodiment the inclined surface is configured to guide a displacement of the at least one ball in an inward direction towards the longitudinal axis (a) during the axial displacement of the outer sleeve by the first biasing element and when the coupling mechanism is moved from the open position to the closed position by pushing the removable tool head and therewith the inner sleeve towards the tool side end of the cavity.

The inclined surface helps to provide a smooth transition between the open position and the closed position by guiding the at least one ball from the inclined surface to the inner projection and back upon displacement of the outer sleeve.

In the open position the at least one ball abuts the inclined surface.

In another embodiment the through hole is a conical through hole with a diameter decreasing towards the longitudinal axis defined by the drive axle so that the at least one ball can be positioned within the through hole and thereby partially extends outwards from the conical through hole into the cavity.

The smallest diameter of the conical through hole is not greater than the diameter of the at least one ball. Then the at least one ball can extend into the cavity and engage the recess when the inner projection is pushing the at least one ball into the conical through hole in the closed position.

In another embodiment the first biasing element comprises a first passage and the second biasing element comprises a second passage, the first passage being arranged to encompass the cavity at least partially and wherein the second passage is designed to receive the drive axle or a connector of the removable tool head.

In a further embodiment the coupling mechanism may comprise at least two balls, preferably four balls, more preferably six balls and even more preferably eight to fourteen balls and wherein the number of through holes in the front end and the number of recesses on the removable tool head are adapted to the number of balls of the coupling mechanism.

The more balls and the more corresponding through holes are provided in the coupling mechanism, the easier it is to rotationally lock the removable tool head in the coupling mechanism and therewith the power tool since only a slight rotation of the removable tool head is necessary in order to engage the number of balls in the number of recesses when the removable tool head is inserted in the cavity of the front end. There is however a limit as to how many balls and recesses can be used due to stability in the bushing of the tool head and the front end of the power tool respectively.

In some embodiments ten or even twelve balls and corresponding through holes and recesses may be provided, basically any number of balls from 1 to 30 or even more and a corresponding number of through holes and recesses may be provided.

In an embodiment the inner sleeve comprises a shoulder designed to abut a tool side end of the removable tool head in the closed position, and wherein the shoulder is designed to push the removable tool head out of the cavity upon manual displacement of the outer sleeve against the biasing force of the first biasing element and therewith when the coupling mechanism is moved into the open position.

This makes it visibly clear to the operator that the removable tool head is disengaged from the power tool so that it can be removed or that it is not properly engaged and needs to be pushed harder or further into the cavity.

In an embodiment the cavity has a generally cylindrical shape and is arranged parallel to the longitudinal axis (a) so that a centre line (a) of the cylindrical shape is congruent with the longitudinal axis (a) defined by the drive axle.

This supports a proper functioning of the inner sleeve and the second biasing element and the outer sleeve and the first biasing element.

In a further embodiment the inner sleeve and the outer sleeve are configured to move parallel and concentric along the longitudinal axis (a), when they are pushed or pulled manually or by the second biasing element and the first biasing element, respectively.

This helps to achieve a proper functioning of the coupling mechanism and reduces the amount of friction, which improves operation of the coupling mechanism.

In all the embodiments mentioned above the outer sleeve may be slid towards the front end of the power tool or away from the front end of the power tool in order to release the removable tool head and move the coupling mechanism from the closed position or locked position into the open position.

In still another embodiment the inner sleeve comprises at least one projecting element, which is projecting towards the open end of the cavity, said projecting element designed to abut the outer sleeve at least in the open position and wherein the biasing force of the first biasing element is smaller than the biasing force of the second biasing element so that the inner sleeve can prevent the displacement of the outer sleeve towards the closed position via the at least one projecting element when the removable tool head is not inserted in the power tool.

The inner sleeve is therewith blocking the outer sleeve from moving into the closed position, in which the inner projection will engage the at least one ball and thereby push the ball into the through hole, which would prevent the removable tool head from being fully inserted into the cavity and from being locked in the power tool.

In a further embodiment the inner sleeve is designed to be displaced towards the tool side end of the cavity upon insertion and manually pushing of the removable tool head towards the tool side end, thereby overcoming the biasing force of the second biasing element so that the outer sleeve can slide into the closed position propelled by the biasing force of the first biasing element thereby first guiding the inclined surface and then the inner projection into abutment with the at least one ball so that the at least one ball is pushed all the way into the through hole thereby extending partially into the cavity for engaging the recess of the removable tool head.

In the embodiments where the inner sleeve is preventing the outer sleeve from moving in the open position, the outer sleeve may be slid away from the front end for removal of the removable tool head and thus for moving the coupling mechanism from the closed position to the open position.

The manual displacement of the inner sleeve will enable the outer sleeve and the first biasing element to engage and push the at least one ball via the inclined surface thereby generating pressure on the at least one ball to move towards the longitudinal axis so that the removable tool head is locked in the cavity as soon as the recess is aligned with the at least one ball, whereby the inclined surface slides over the ball so that the inner projection finally presses the at least one ball into the through hole and the recess.

In another embodiment the inner sleeve comprises a lateral surface, said lateral surface being arranged to abut the at least one ball, thereby preventing the at least one ball from extending into the cavity in the open position.

In the above embodiment the at least one ball is prevented from being pushed fully into the through hole via the inclined surface by the lateral surface of the inner sleeve. As soon as the inner sleeve is displaced when the removable tool head is inserted and the biasing force of the second biasing element is overcome the lateral surface will move out of the way of a path of the at least one ball so that the inclined surface of the outer sleeve can push the at least one ball fully into the through hole and therewith engage the recess of the removable tool head as soon as the recess is aligned with the through hole and the ball, respectively.

In still another embodiment the inner sleeve and thereby the lateral surface is displaced towards the tool side end of the cavity and out of abutment with the at least one ball, upon insertion and manually pushing of the removable tool head towards the tool side end of the cavity, thereby overcoming the biasing force of the second biasing element so that the outer sleeve can slide, propelled by the biasing force of the first biasing element, thereby moving the inclined surface into abutment with the at least one ball and then the inner projection into abutment with the at least one ball so that the at least one ball can engage in the recess on the removable tool head so that the coupling mechanism is moved into the closed position.

In another embodiment the outer sleeve further comprises one more inclined surface symmetrically adjacent the inner projection, wherein the neutral point of the first biasing element is chosen so that inner projection abuts the at least one ball when the first biasing element is in the neutral point, which corresponds to the closed position of the coupling mechanism.

This may enable an operator to either move the outer sleeve away or towards the front end of the power tool for releasing the removable tool head and therewith for moving the coupling mechanism from the closed position into the open position.

In another solution the inner projection extends from the inner side of the outer sleeve towards the longitudinal axis (a) and comprises a flat top portion, the flat portion being configured to abut the at least one ball in the closed position of the coupling mechanism.

The flat top portion may improve robustness of the coupling mechanism and compensate for manufacturing tolerances.

The invention and many embodiments have now been described above. It is clear to the skilled person that the above embodiments can be combined in many ways and that the features of all embodiments can be used in other embodiments. Such embodiments are herewith included in this disclosure.

### BRIEF DESCRIPTION OF THE DRAWINGS

The present invention will now be described, for exemplary purposes, in more detail by way of an embodiment(s) and with reference to the enclosed drawings, in which:

FIG. 1 schematically illustrates a power tool having a removable angled tool head, for example for tightening purposes;

FIG. 2a schematically illustrates a cross-sectional view of the power tool of FIG. 1 with the removable angled tool head engaged and locked in the power tool and a coupling mechanism in a closed position;

FIG. 2b schematically illustrates an enhanced section of FIG. 2a illustrating a detailed part of the coupling mechanism;

FIG. 3 schematically illustrates a cross-sectional view of the power tool of FIG. 1 with the removable angled tool head disengaged and the coupling mechanism in an open position;

FIG. 4 schematically illustrates a cross FIG. 4 sectional view of another embodiment of the invention, with a removable angled tool head disengaged from the power tool, with a coupling mechanism in an open position;

FIG. 5 schematically illustrates a cross sectional view of another embodiment of the invention, with a removable angled tool head engaged in the power tool and a coupling mechanism in the closed position;

FIG. 6 schematically illustrates still another embodiment of the present invention in the form of a power tool shown as a screwdriver or drilling machine having a removable tool head;

FIG. 7 schematically illustrates a cross sectional view with the removable tool head engaged in the power tool and a coupling mechanism in the closed position; and

FIG. 8 schematically illustrates a cross sectional view of the power tool of FIG. 6 with the removable tool head disengaged and the coupling mechanism in an open position.

### DETAILED DESCRIPTION

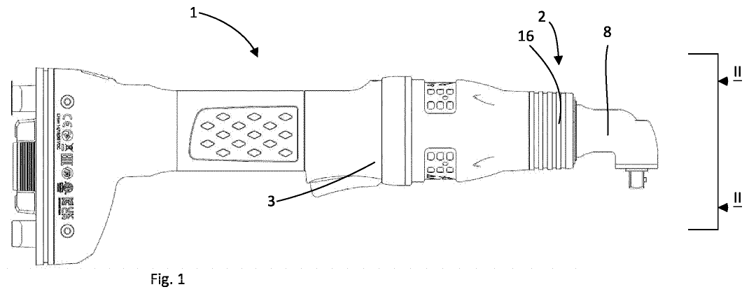

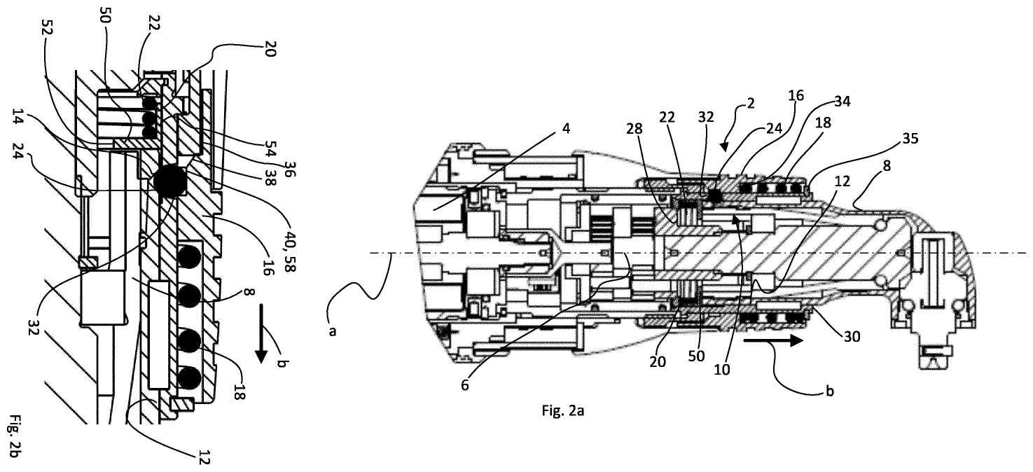

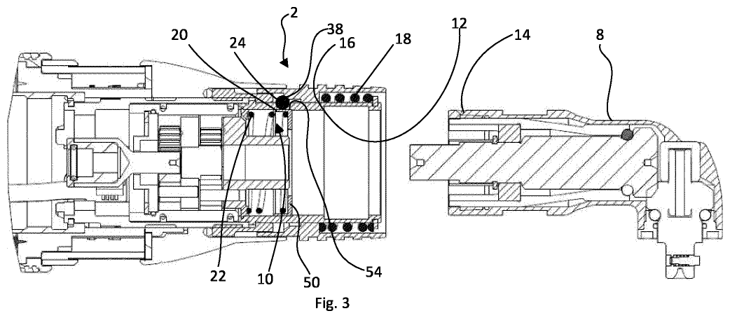

FIG. 1 illustrates a power tool 1 for tightening comprising a front end 2 and a removable angled tool head 8 used for tightening of screws and bolts. In the embodiment illustrated in FIG. 1 the removable angled tool head 8 is locked and engaged in the power tool 1. FIG. 2a illustrates a cross sectional view of a front part of the power tool 1 according to FIG. 1, namely with the removable tool head 8 engaged in the power tool 1 and a coupling mechanism 10 in a closed position. Turning back to FIG. 1, the power tool 1 further comprises an outer sleeve 16 for disengaging the removable angled tool head 8 by pushing the outer sleeve 16 forward from the power tool body 3 towards the removable angled tool head 8 so that it can be slid outwards away of the front part of the power tool 1 to replace the removable angled tool head 8 with another tool head. FIG. 3 illustrates a cross sectional view of the front part of the power tool 1 with the removable tool head 8 disengaged and the coupling mechanism 10 in an open position.

FIG. 2a is illustrating a cross sectional view cut along plane II-II illustrated in FIG. 1 and along the longitudinal axis a defined by the drive axle or gear train or gear box 6. The power tool 1 comprises the front end 2, a motor 4, the drive axle 6 connected to the motor 4, the removable tool head 8 and the coupling mechanism 10.

The front end 2 comprises a cavity 12 having a tool side end 28, a free end 30 and at least one through hole 32 for receiving at least one ball 24 of the coupling mechanism 10. The front end 2 is sleeve shaped and the at least one through hole 32 is designed to point towards the longitudinal axis a defined by the drive axle 6.

The coupling mechanism 10 comprises the outer sleeve 16, a first biasing element 18, an inner sleeve 20, a second biasing element 22 and at least one ball 24. The outer sleeve 16 is arranged around the circumference of the front end 2 and can be manually biased against the resistance of the first biasing element 18, which acts upon the outer sleeve 16 in a direction towards the body of the power tool 1. The first biasing element 18 abuts a stop 35 at or at least close to the free end 30 of the cavity 12 an inner shoulder 34 of the outer sleeve 16 so that it can push the outer sleeve 16 in a direction that is 180 degrees turned and therewith exactly opposite a direction of an arrow b shown in FIG. 2.

If the outer sleeve 16 is moved in a direction as indicated by the arrow b in FIG. 2b and thus towards the free end 30 of the cavity 12 of the front end 2 or towards the removable tool head 8. This will now be explained in more detail referring to FIG. 2b.

FIG. 2b illustrates a detailed part of the outer sleeve 16 and the inner sleeve 20. The outer sleeve 16 comprises an inner surface 36, adjacent the inner surface 36 an inclined inner surface 38 and adjacent the inclined inner surface 38 an inner projection 40 having a flat portion 58, which is projecting from the outer sleeve 16 towards the inside of the cavity 12 and/or the longitudinal axis a (c.f. FIG. 2a). In the closed position of the coupling mechanism 10 the inner projection 40 abuts the at least one ball 24 pressing it into the through hole 32 of the front end 2. The at least one ball thereby extends partially into the cavity 12 for engaging a recess 14 in the removable tool 8. The through hole 32 may have a conical design with a decreasing diameter towards the cavity 12 so that the at least one ball 24 can easily extend in partial fashion when it is fully and snugly positioned in the through hole 32.

The inner surface 36, the inclined inner surface 38 and the inner projection 40 with its flat portion 58 may be arranged circumferentially around the inner side of the outer sleeve 16. Alternatively, the inner surface 36, the inclined inner surface 38 and the inner projection 40 with its flat portion 58 may be arranged to be located on the inner side of the outer sleeve 16 in order to engage the at least one ball 24 or several balls 24, whereby the number of the inner surfaces 36, the inclined inner surfaces 38 and the inner projections 40 with its flat portions 58 would be adapted accordingly if they are not continuously circumferentially arranged. Preferably the inner surface 36, the inclined inner surface 38 and the inner projection 40 with its flat portion 58 are arranged circumferentially continuous around the inner side of the outer sleeve 16.

In FIG. 2b the inner sleeve 20 is also illustrated, said inner sleeve 20 comprising a shoulder 50 arranged at a front end of the inner sleeve 20, said front end being directed towards the free end 30 of the cavity 12. The inner sleeve 20 and the second biasing element 22 additionally comprise a recess 52 or central passage for letting a drive axle 6 of the power tool 1 or a shaft of the removable tool head 8 pass. Adjacent the shoulder 50 the inner sleeve further comprises a lateral surface 54, which lateral surface 54 is adapted to slide in the cavity 12 in a snug manner, thus smoothly along the inner surface of the cavity 12. An inner diameter of the cavity 12 is thus at least more or less corresponding to an outer diameter of the inner sleeve 20 in area where the inner sleeve 20 is moving back and forth while at the free end 28 it is held in place and cannot exit from the cavity 12 due to an edge that has a diameter smaller than the diameter of the inner sleeve 20.

As one can see from FIG. 2b upon manual sliding or movement of the outer sleeve 16 towards the removable tool head 8 or free end 30 of the cavity 12 and against the biasing force of the first biasing element 18. Thereby the inner projection 40 and the flat top portion 58 disengage from abutment with the at least one ball 24 so the inclined surface 38 abuts and gets into contact with the at least one ball 24 where the at least one ball 24 starts to move away and out of the recess 14 of the removable tool head 8. As soon as the outer surface of the at least one ball 24 is flush with the inner surface of the cavity 12, the inner sleeve 20 will then, via the shoulder 50, push the removable tool head 8 out of the cavity 12 driven by the biasing force of the second biasing element 22 and the lateral surface 54 of the inner sleeve 20 will slide over the through hole 32 thereby blocking the at least one ball 24 from full or snug engagement with the through hole 32 when the removable tool head 8 is removed from the cavity 12. During the described movement the inclined inner surface 38 will slide over the at least one ball 24 abuts the at least one ball 24 putting the coupling mechanism 10 into the open position. Alternatively, to the inclined inner surface 38 abutting the at least one ball 24, the coupling mechanism 10 may be designed so that the inner surface 36 abuts the at least one ball 24. This open position is shown in FIG. 3, which we will now describe.

FIG. 3 illustrates the coupling mechanism 10 in the open position in which the lateral surface 54 of the inner sleeve 20 is basically closing through hole 32 (c.f. FIG. 2b) and thereby preventing the at least one ball 24 from entering the recess 14 of the removable tool head 8 but also keeping the power tool 1 open so that an operator can easily slide another removable tool head into the power tool 1 without the need for pulling or pushing the outer sleeve 16. The only thing the operator will need to do is to push the other removable tool head against the biasing force of the second biasing element 22 so that the lateral surface 54 moves away from the through hole 32 and the at least one ball 24 can slide into engagement with the recess of the other removable tool head as explained above. In the open position as shown in FIG. 3, the first biasing element 18 is in compressed position or status and is pre-tensioning the outer sleeve 16 towards the power tool 1 but the movement is blocked by the at least one ball 24 and the lateral surface 54 of the inner sleeve. FIG. 3 further illustrates well how the inner sleeve 20 is designed to push the removable tool head 8 out of the cavity 12 via the shoulder 50 and the second biasing element 22.

The first and second biasing element 18, 22 may be hydraulic cylinders, elastomers or other form of rubber cushions or elastic elements and/or springs as shown in the figures. This configuration is possible shown in all embodiments herein.

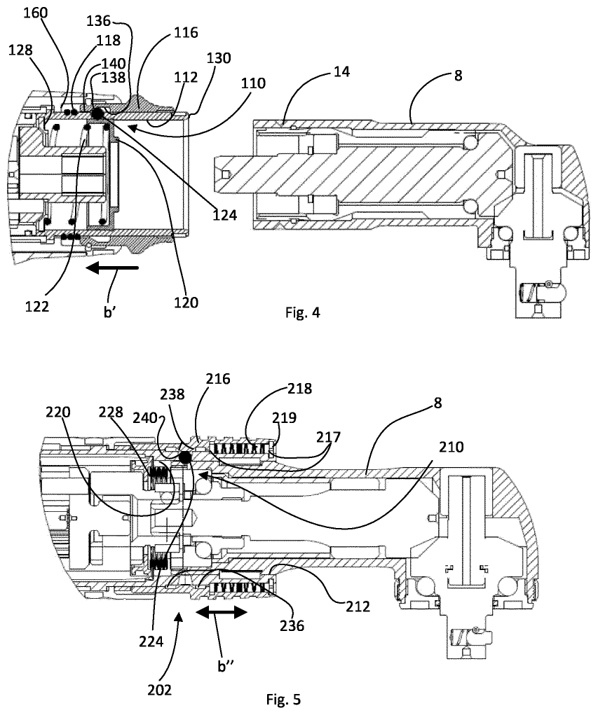

The coupling mechanism 10 as shown in FIGS. 1 to 3 can be released by manually sliding the outer sleeve 16 in the direction of the arrow b thus towards the removable tool head 8, when the tool head 8 is engaged in the power tool 1. It is however possible to design the coupling mechanism 110 so that the outer sleeve 116 can be slid towards the power tool 1 instead for release of the removable tool head 8. This will now be explained referring to FIG. 4.

In FIG. 4 a modified coupling mechanism 110 is shown in which the outer sleeve 116 still comprises the inner surface 136, adjacent the inner surface 136, the inclined inner surface 138 and adjacent the inclined inner surface 138 the inner projection 140 having the flat top portion (c.f. FIG. 2b). In this case the inner surface 136, the inclined inner surface 138 and the inner projection 140 are however arranged in another sequence than in FIGS. 2a, 2b and 3 where the inner surface 36 is arranged closed to the tool side end 28 of the cavity 12 then the inclined inner surface 38 and finally the inner projection 40 closest to the free end 30 of the cavity 12. In embodiment shown in FIG. 4, the inner surface 136 is arranged closest to the free end 130 of the cavity 112, the inclined inner surface 140 in the middle of the inner surface 136 and the inner projection 140. The inner projection 140 with its flat top portion is arranged closed to the tool side end 128 of the cavity 112. This means that in the embodiment of FIG. 4 the outer sleeve 116 can be manually slid towards to power tool 1 or the tool side end 128 of the cavity 112 for release of the removable tool head 8, as indicated by the arrow b′. The inner sleeve 120 and the first biasing element 122 are designed similar to the inner sleeve and first biasing element shown in FIGS. 1 to 3. The first biasing element 118 is abutting the outer sleeve 116 and a shoulder 160 of the power tool 1, which is arranged close the tool side end 128 of the cavity 112. The coupling mechanism 110 works otherwise in the same manner as described referring to FIGS. 1 to 3.

In view of the embodiments shown in FIGS. 1 to 3 and 4, in which the outer sleeve 16, 116 can be slid forward or backwards for release of the removable tool head 8, it is also possible to provide an outer sleeve 216 that can be slid in a forward or backward direction for release of the removable tool head 8 and thus for moving the coupling mechanism 210 into the open position. Such an embodiment is schematically illustrated in FIG. 5.

The outer sleeve 216 indicated in FIG. 5 comprises two inclined inner surfaces 238 and two inner surfaces 236, which may or may not be arranged circumferential around the inner side of the outer sleeve 216. The two inclined inner surfaces 238 are arranged symmetrically around the inner projecting portion 240 and on outer sides of the respective inclined inner surfaces 238 the two inner surfaces 236. The second biasing element 218 is arranged in between a pair of washers or ring-shaped elements 217, which abut a shoulder on the outer sleeve 216 at the tool side end of the cavity 212 and another washer 219 fixedly connected to the front end 202 of the power tool 1. The washer 219 is provided in two parts or may be two washers 219 whereby the inner part is fixedly engaged or connected to the front end 202 of the power tool at an outer side of the cavity 212 and whereby the outer part of the washer 219 is fixedly connected to the outer sleeve 216. This design enables the compression of the first biasing element 218 in both cases thus when the outer sleeve 216 is moved towards or away from the tool side end 228 or the front end of the cavity 212 or moved away from or towards the removable tool head 8 when the tool is engaged and locked in the power tool 1 for release of the tool head 8. The release movement is indicated by the double arrow b″ in FIG. 5. Again, the design of the inner sleeve 220 is the same or similar as described previously referring to FIGS. 1 to 4 and so is the engagement and disengagement of the at least one ball 224 in the recess and the through hole upon manually sliding the outer sleeve 216 when the coupling mechanism 210 is in the closed position and upon insertion of another tool head when the coupling mechanism is in an open position 210.

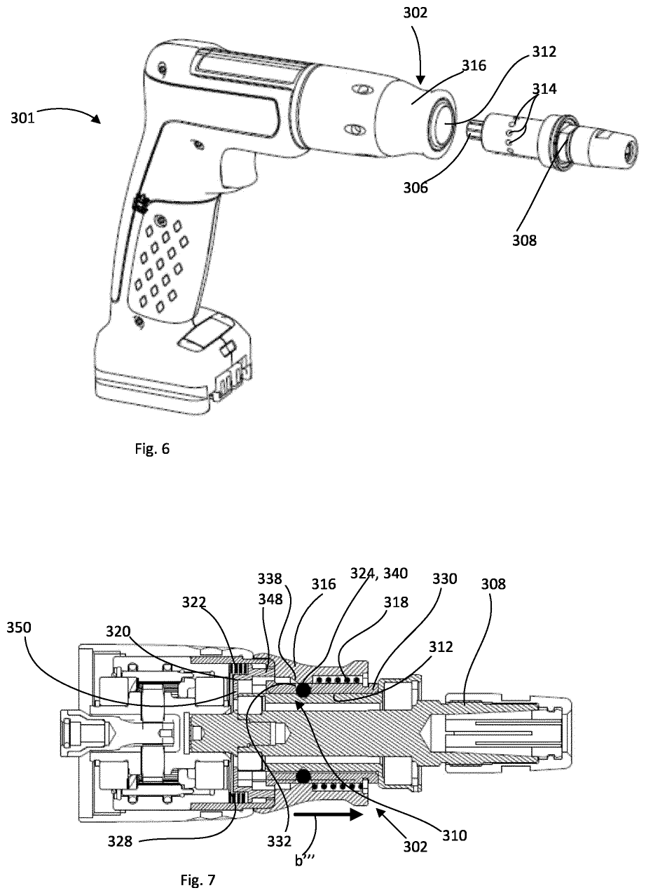

Another embodiment of the invention will now be described referring to FIGS. 6 to 8, which illustrate a power tool 301 in the form of a handheld drill comprising a removable tool head 308, a drive axle 306 and an outer sleeve 316. The removable tool head 308 of FIG. 2 comprises several recesses 314, about 10 to 14 in total and accordingly a similar number of balls 324 although it is possible to use less balls than recesses 314. The other embodiments shown herein can comprise a similar number of balls 324 and corresponding recesses 314 or less balls 324.

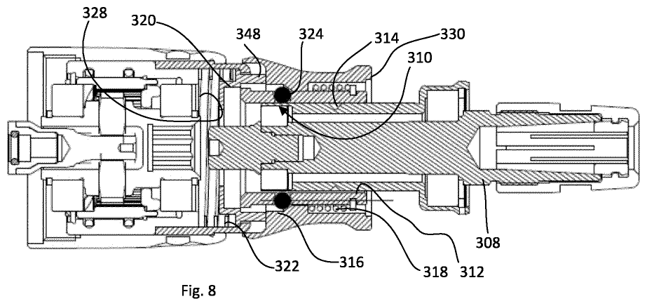

In FIG. 6 the cavity 312 of the front end 302 of the power tool 301 is well visible, which cavity 312 is configured to receive the removable power tool 308. The coupling mechanism 310 (c.f. FIG. 7) is in the open position ready to receive the removable tool head 8. The embodiments illustrated in FIGS. 1 to 5 have shown that the coupling mechanism 10, 110, 210 uses the inner sleeve 20, 120, 220 to block a re-engagement of the at least one ball 24, 124, 224 when the coupling mechanism 10, 110, 210 is in the open position. The invention disclosed herein also covers the solution where the inner sleeve 320 is blocking the outer sleeve 316 from retracting into a closed position, in which the at least one ball 324 is pushed into the recess 314 of the removable tool head 308 and into the through hole 332. In such a solution the biasing force of the first elastic element 318 is smaller than the biasing force of the second elastic element 322. This embodiment will now be described referring to FIGS. 7 and 8.

FIG. 7 illustrates the coupling mechanism 310 in the closed position with the removable tool head 308 engaged in the cavity 312 of the front end 302 of the power tool 301. The at least one ball 324, in the present embodiment there are 12 (twelve) balls 324 and twelve recesses 314 present in the removable tool head 308, is fully pressed into and engaged in the conical through hole 332 and into the recess(es) 314. The inner projection 340 having a flat top portion is abutting the ball(s) 324.

The inner sleeve 320 is biased towards the tool side end 328 of the cavity 312 and the second biasing element 322 is compressed and pre-tensioned. The inner sleeve 320 comprises a pair of projecting elements 348 that extend through recess in the front end 302. The projection elements 348 may be fingers or the like. The projecting elements 348 are however not circumferentially continuous arranged around the inner sleeve 320 but designed, as explained, like fingers, shafts, or board like elements. In the closed position of the coupling mechanism 310, as shown in FIG. 7, the projecting elements 348 may touch the outer sleeve 316 but they do not apply any pressure onto the outer sleeve 316 since the removable tool head 308 is absorbing the force of the second biasing element 322 in this case so that the biasing force of the first biasing element 318 can do its job and push the outer sleeve 316 towards the tool side end 328 of the power tool 301 in order to block the ball(s) 324 from moving out of the conical through hole 332 via the inner projection 348. The movement of the inner sleeve 320 is thus blocked by the tool head 308 in the closed position. The operator will thus have to push the tool head 308 into the cavity 312 against the biasing force of the second biasing element 322. When the operator wants to remove the tool head 308 from the power tool the outer sleeve 316 is manually pushed towards the free end 330 of the cavity 312 so the ball(s) 324 can slide from the inner projection 340 to the inclined surface 338 so that the ball(s) 324 disengages from the recess' (314) due pressure generated by the second biasing element 322, which results in that the tool head 308 pushed out of the cavity 312 driven by the second biasing element 322 and the inner sleeve 320, as shown in FIG. 8.

FIG. 8 illustrates the coupling mechanism 310 in an open position, even though the tool head 308 is still partially embedded in the cavity 312. The first biasing element 322 is extended and has the removable tool head 308 being pushed out of the cavity 312. The projecting element(s) 348 of the inner sleeve 320 are in abutment with the outer sleeve 316 and since the biasing force of the second biasing element 322 is greater than the biasing force of the first biasing element 318 the outer sleeve 316 cannot slide back towards the tool side end 328 of the cavity 312, even though the first biasing element 318 is compressed. Once the operator is ready to insert another tool head, she/he will slide the coupling shaft into the cavity 312 and press the tool head 8 against the force generated by the second biasing element 322 until the ball(s) 324 engage in the recess' 314.

In order for the projecting elements 348 or the projections to abut the outer sleeve 316 it is necessary to provide some form of recesses (not visible in FIGS. 7 and 8) in the front end 302 of the power tool. In any case the inner sleeve 320 may comprise one, two, three, four or more projecting elements 348 and the front end 302 corresponding recesses.

The inner sleeve 320 shown referring to FIGS. 6 to 8 may further comprise the shoulder 350 which shoulder abuts the tool side end of the removable tool head 308 in the closed position of the coupling mechanism 310, as shown in FIG. 7 and which shoulder 350 is used to push the removable tool head 308 at least partially out of the cavity 312 upon releasing the closed position via the outer sleeve 316 and during the movement of the coupling mechanism 316 from the closed into the open position.

It is to be noted that the embodiment of the coupling mechanism 310 shown in FIGS. 6 to 8 can be embedded in the embodiments shown in FIGS. 1 to 5 as well. Some features may even be isolated such as for instance the number of balls 24, 124, 224, 324 or the use of the inner sleeve 20, 120, 220, 320 with the projecting element 348.

In the embodiments shown in the figures the first and second biasing elements 18, 118, 218, 318, 22, 122, 222, 322 are design with passages in the center to receive the front end 2, 102, 202, 302 (first biasing element) or the drive axle 6 and/or shaft of the removable tool head 8 and/or cables or the like for connecting sensors at the front end 2, 102, 202, 302 to the electronics of the power tool.

In the embodiments shown herein the outer sleeve 16, 116, 216, 316 is arranged around the outer side of the front end 2, 102, 202, 302.

The recesses 14, 314 illustrated in the removable tool heads 8, 308 are preferably in the shape of a flipped cone and V-shaped.

The smallest diameter in the through hole 32, 132, 232, 332 is always smaller than the diameter of the at least one ball 24, 124, 224, 324 but it is chosen so that a part of the at least one ball 24, 124, 224, 324 extends into the cavity 12, 112, 212, 312 to that this part can engage in the recesses 14, 314 in the closed position of the coupling mechanism 10, 110, 210, 310.

The power tool 1 illustrated in the figures may preferably be a battery driven power tool.

1. A power tool comprising:
a motor;
a drive shaft connected to the motor, the drive shaft defining a longitudinal axis;
a front end having at least one through hole, said front end defining a cavity comprising a tool side end and a free end; and
a coupling mechanism for releasably connecting a removable tool head to the drive shaft, the coupling mechanism comprising an outer sleeve arranged at least partially around the cavity, the coupling mechanism further comprising a first biasing element, at least one ball arranged at least partially within the at least one through hole and on an inner side of the outer sleeve, the outer sleeve comprising an inclined inner surface and an inner projection adjacent to the inclined inner surface, the first biasing element being arranged at the front end abutting the outer sleeve and the front end, the coupling mechanism being arranged to be moved between an open position, in which the power tool can receive the removable tool head and a closed position, in which the removable tool head is connected to and locked in the power tool, whereby in the open position the at least one ball can be displaced in an outward direction away from the longitudinal axis and in the closed position the displacement in the outward direction of the at least one ball is prevented by the inner projection of the outer sleeve,
wherein the coupling mechanism further comprises an inner sleeve arranged at least partially within the cavity, and a second biasing element abutting the tool side end of the cavity and the inner sleeve, whereby in the open position the inner sleeve is preventing the inner projection from abutting the at least one ball, wherein the inner sleeve comprises at least one projecting element, which is projecting towards the free end of the cavity, said projecting element designed to abut the outer sleeve at least in the open position and wherein the biasing force of the first biasing element is smaller than the biasing force of the second biasing element so that the inner sleeve can prevent the displacement of the outer sleeve towards the closed position via the at least one projecting element when the removable tool head is not inserted in the power tool, or
wherein the inner sleeve comprises a lateral surface said lateral surface being arranged to abut the at least one ball in the open position of the coupling mechanism, thereby preventing the at least one ball from extending into the cavity in the open position.

2. The power tool according to claim 1, wherein in the closed position the inner sleeve is biased towards the tool side end by the removable tool head thereby allowing the displacement of the at least one ball inwards into the through hole and towards the longitudinal axis by the inner projection of the outer sleeve, so that the at least one ball extends partially into the cavity for engagement of at least one recess of the removable tool head, thereby locking the removable tool head in the power tool.

3. The power tool according to claim 1, wherein the inclined surface is configured to guide a displacement of the at least one ball in an inward direction towards the longitudinal axis the axial displacement of the outer sleeve by the first biasing element and when the coupling mechanism is moved from the open position to the closed position by pushing the removable tool head and therewith the inner sleeve towards the tool side end of the cavity.

4. The power tool according to claim 1, wherein the through hole is a conical through hole with a diameter decreasing towards the longitudinal axis and chosen so that the at least one ball can be positioned within the through hole and thereby partially extends outwards from the conical through hole into the cavity.

5. The power tool according to claim 1, wherein the first biasing element comprises a first passage and wherein the second biasing element comprises a second passage, the first passage being arranged to encompass the cavity at least partially and wherein the second passage is designed to receive the drive shaft or a connector of the removable tool head.

6. The power tool according to claim 1, wherein the coupling mechanism comprises at least two balls or more and wherein the number of through holes in the front end and the number of recesses on the removable tool head are adapted to—or exceed the number of balls of the coupling mechanism.

7. The power tool according to claim 1, wherein the inner sleeve comprises a shoulder, the shoulder being designed to abut a tool side end of the removable tool head in the closed position, and wherein the shoulder is designed to push the removable tool head out of the cavity upon manual displacement of the outer sleeve against the biasing force of the first biasing element and therewith when the coupling mechanism is moved into the open position.

8. The power tool according to claim 1, wherein the cavity has a generally cylindrical shape and is arranged parallel to the longitudinal axis so that a center-centre-line of the cylindrical shape is congruent with the longitudinal axis defined by the drive shaft.

9. The power tool according to claim 1, wherein the inner sleeve and outer sleeve are configured to move parallel and concentric along the longitudinal axis when they are pushed or pulled manually or by the second biasing element and the first biasing element, respectively.

10. The power tool according to claim 1, wherein the inner sleeve is designed to be displaced towards the tool side end of the cavity upon insertion and manually pushing of the removable tool head towards the tool side end, thereby overcoming the biasing force of the second biasing element so that the outer sleeve can slide into the closed position propelled by the biasing force of the first biasing element thereby first guiding the inclined surface and then the inner projection into abutment with the at least one ball so that the at least one ball is pushed all the way into the through hole thereby engaging the recess on the removable tool head and moving the coupling mechanism into the closed position.

11. The power tool according to claim 1, wherein the inner sleeve and thereby the lateral surface is displaced towards the tool side end of the cavity and out of abutment with the at least one ball, upon insertion and manually pushing of the removable tool head towards the tool side end of the cavity, thereby overcoming the biasing force of the second biasing element so that the outer sleeve can slide, propelled by the biasing force of the first biasing element, thereby moving the inclined surface out of abutment with the at least one ball and then the inner projection into abutment with the at least one ball so that the at least one ball engages the recess on the removable tool head so that the coupling mechanism is in the closed position.

12. The power tool according to claim 1, wherein the outer sleeve further comprises one more inclined surface adjacent the inner projection and wherein the neutral point of the first biasing element is chosen so that the inner projection abuts the at least one ball when the first biasing element is in the neutral point, which corresponds to the closed position of the coupling mechanism.

13. The power tool according to claim 1, wherein the inner projection extends from the inner side of the outer sleeve towards the longitudinal axis and comprises a flat top portion, the flat portion being configured to abut the at least one ball in the closed position of the coupling mechanism.

14. (canceled)

15. (canceled)
